(19) United States
(12) Patent Application Publication
(10) Pub. No.: US 2008/0205767 A1
(43) Pub. Date: Aug. 28, 2008

(54) Extraction method, extraction apparatus, program, drawing data creation method, and drawing data creation apparatus

(75) Inventors: Takashi Hoshino, Kanagawa (JP); Takashi Toyofuku, Kanagawa (JP); Yasuyuki Mochizuki, Kanagawa (JP); Yukihisa Ozaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Ashigara-kami-gun (JP)

(21) Appl. No.: 12/068,960

(22) Filed: Feb. 13, 2008

(30) Foreign Application Priority Data
Feb. 14, 2007 (JP) 2007-033435
Mar. 29, 2007 (JP) 2007-086532

(51) Int. Cl. G06K 9/46

(52) U.S. Cl. 382/192

(57) ABSTRACT

The extraction method and apparatus acquire design data that has a hierarchical structure and is converted into raster data corresponding to drawing onto a substrate and extract from the design data a structural element that composes the design data, is repeatedly described in one hierarchical layer, and satisfies at least one of four extraction conditions concerning a size of the structural element, a number of times of repetition of the structural element in a structural element upper than the structural element, a number of lower structural elements composing the structural element, and a depth of the one hierarchical layer in which the structural element exists.

The entire contents of all documents cited in this specification are incorporated herein by reference.

### BACKGROUND OF THE INVENTION

The present invention relates to an extraction method, an extraction apparatus, and a program that extract each predetermined structural element (data to form a structural unit) from design data in a drawing system to draw an image of a specific pattern on a substrate, such as an exposure system in which an image is exposed, for producing a liquid crystal display or the like, in order to accelerate data processing to convert design data into image data (drawing data or image forming data) corresponding to the image drawing onto a substrate in a drawing apparatus, such as image data (exposure data) corresponding to the image exposure in an exposure apparatus.

Further, the present invention relates to a drawing data creation method and a drawing data creation apparatus that create drawing data corresponding to drawing onto a substrate by rasterizing design data in which an image to be drawn on the substrate is described in a vector form, and in particular, relates to a drawing data creation method and a drawing data creation apparatus with which it becomes possible to, when a substrate of a liquid crystal display or the like is designed and produced, shorten a time necessary for the substrate production even when a design is changed.

There is known a digital exposure machine which, in a manufacturing process of a printed wiring board or the like, performs exposure of a substrate that becomes the printed wiring board with recording light modulated in accordance with image data. Also, there is desired a digital exposure machine which, also in a manufacturing process of a liquid crystal display (LCD) panel or the like, performs exposure of a substrate for production of TFTs or the like with recording light modulated in accordance with image data.

In manufacturing an LCD panel or the like using a digital exposure machine, it is required to create digital mask data (drawing data) for generating image data (hereinafter, referred to as “exposure data”) for image exposure in the digital exposure machine (hereinafter, referred to as “exposure machine”) from design data created by a designer.

In manufacturing an LCD panel or the like described above, a manufacturer first performs design of a product to be manufactured such as an LCD panel, using a design tool such as computer aided design (CAD).

In this case, in image exposure in a digital exposure machine, multiple products may be produced with one substrate in order to improve productivity. Therefore, a designer arranges (data of) multiple designed products on a substrate in accordance with a size of the substrate (sheet size) that becomes an exposure target to obtain design data corresponding to an image to be exposed with the exposure machine.

For instance, when the substrate that becomes an exposure target is a substrate (2,200×2,400 mm) of G8 (eighth generation) in LCD panel manufacturing, design data in which an image to be exposed with the exposure machine is described is obtained by arranging (laying out) multiple pieces of data of a designed LCD panel on the substrate in accordance with this substrate of G8 size.

This design data by a design tool is based on a data format called GDI II, a data format called ODB++, or a data format called RS247X, and is ordinarily described in a vector form (image data in a vector form). Therefore, in order to enable the image exposure (drawing) in the exposure machine, conversion of this design data into raster data (bitmap data) by a raster image processor (RIP) is required.

In a system in which exposure of a substrate is performed by a digital exposure machine, after design data is converted into raster data, the raster data is compressed as necessary and is transferred to, for instance, the exposure machine as digital mask data (drawing data). After receiving the digital mask data, the exposure machine generates exposure data corresponding to image exposure by an exposure head (exposure optical system) in the exposure machine by performing necessary processing such as decompression and various data processing on the digital mask data and performs the exposure of the substrate in accordance with this exposure data.

As a matter of course, when a size of a substrate to be subjected to image exposure increases, a data amount increases and a time required for data transfer and processing becomes longer. In particular, a time required for conversion of design data into raster data and compression of the raster data becomes longer in accordance with the increase of the size of the substrate, which becomes one factor of lowering productivity.

For instance, when the substrate of G8 described above is used in LCD panel manufacturing, drawing (exposure) is performed on the substrate of 2,200×2,400 mm size at a resolution of 0.5 μm, 0.25 μm, or the like, so an enormous amount of time is required for conversion into raster data and compression of the raster data. In particular, an enormous amount of time that is several hours to several ten hours is consumed by the conversion into the raster data.

As a method of avoiding such inconvenience and making it possible to perform generation of digital mask data at high speed, there is disclosed a method in JP 2006-254190 A and JP 2006-251036 A. In the method described above, each of multiple structural elements that exist in design data (structural element repeatedly described on the design data, or structural element data) is regarded as one part (part data) composing the design data, and only one part (part data) is converted into raster data to obtain the raster data of the part and position information (layout information) of the part on a substrate, so that raster data corresponding to the digital mask data can be held.

With this method, it becomes possible to perform conversion of design data into raster data and compression of the raster data after the conversion, which take the longest time, with efficiency and therefore it becomes possible to reduce a time required for generation of digital mask data.

This method will be described in more detail.

As described above, design data is obtained by arranging multiple designed products (design data of products) on one substrate.

When a substrate of G5 (1,300×1,100 mm) is used in manufacturing one kind of 15-inch LCD panel, for instance, design data for image exposure in an exposure machine is obtained by arranging 16 pieces of data of the designed LCD panel on the substrate in four rows and four columns.

Accordingly, in this case, raster data corresponding to digital mask data can be held by regarding data of the LCD panel as one part composing the design data corresponding to the image exposure, converting only one piece, out of 16 pieces, of data of the LCD panel into raster data, preferably further compressing the raster data, and holding only this raster data and position information of the LCD panel on the substrate.

After this, the digital mask data is generated by synthesizing the raster data corresponding to the image exposure onto the substrate through arrangement of the compressed raster data of the LCD panel at each position of the LCD panel in accordance with the position information. This digital mask data is transferred to the exposure machine, at which exposure data corresponding to the image exposure by the exposure machine is obtained by performing necessary processing such as decompression.

With this method, it is sufficient that in a process for generating digital mask data from design data, multiple pieces of data of an LCD panel to be arranged are represented by one part (part data) and only one part data is converted into raster data, so it becomes possible to shorten a time required for this conversion, and in addition, it is sufficient to compress only the thus-converted raster data. In other words, it becomes possible to reduce a time required for the conversion of the design data into the raster data and the compression of the raster data, which require the longest time, to thereby improve productivity by generating the digital mask data at high speed.

Under present circumstances, however, it is required for an operator operating a drawing system such as an exposure system to judge which structural element should be regarded as a part and operate to input/designate the part. This places a burden on the operator and makes it impossible to start conversion of design data into raster data before the part designation by the operator is made, so there is a case where a longer time is required for the data conversion.

Also, under present circumstances, when a design of an LCD panel is changed, it is necessary to modify design data and create exposure data again. Therefore, when a design is changed, a series of processes in which image exposure is performed on a substrate and then the image exposure with the change is verified becomes longer due to a data conversion time for obtaining exposure data from design data, which leads to a problem that an enormous amount of time is required under present circumstances.

Further, also when a problem occurs to image exposure due to design data, it is necessary to solve the problem of the exposure by modifying the design data. Also in this case, it is necessary to modify the design data and create exposure data again, which leads to a problem that an enormous amount of time is required.

### SUMMARY OF THE INVENTION

A first object of the present invention is to solve the problems of the conventional technologies described above and to provide an extraction method and an extraction apparatus, with which, in data processing for generating digital mask data from design data in image exposure of a substrate in manufacturing an LCD panel or the like, when acceleration of the processing is aimed to achieve by regarding each structural element that is repeatedly described on the design data as a part, it becomes possible to automatically extract the structural element to be regarded as a part, and therefore it becomes possible to alleviate a burden on an operator operating a system and quickly perform conversion of the design data into raster data.

Further, a second object of the present invention is to solve the problems of the conventional technologies described above, and to provide a drawing data creation method and a drawing data creation apparatus, with which, when a substrate of a liquid crystal display or the like is designed and produced, even when a design is changed, it becomes possible to shorten a time required for the production of the substrate.

In order to attain the first object described above, a first embodiment of a first aspect according to the present invention provides an extraction method, comprising: an acquiring step of acquiring design data that has a hierarchical structure and is converted into raster data corresponding to drawing onto a substrate; and an extracting step of extracting from the design data a structural element that composes the design data, is repeatedly described in one hierarchical layer, and satisfies at least one of four extraction conditions concerning a size of the structural element, a number of times of repetition of the structural element in an upper structural element upper than the structural element, a number of lower structural elements composing the structural element, and a depth of the one hierarchical layer in which the structural element exists.

And, a second embodiment of the first aspect according to the present invention provides an extraction apparatus comprising: an acquisition section for acquiring design data that has a hierarchical structure and is converted into raster data corresponding to drawing onto a substrate; and an extraction section for analyzing the design data acquired by the acquisition section to extract a structural element that composes the design data, is repeatedly described in one hierarchical layer, and satisfies at least one of four extraction conditions concerning a size of the structural element, a number of times of repetition of the structural element in an upper structural element upper than the structural element, a number of lower structural elements composing the structural element, and a depth of the one hierarchical layer in which the structural element exists.

Here, preferably, the extraction section includes: first selection means for selecting the at least one of four extraction conditions; and means for determining a threshold value for judging whether satisfying the at least one of the four extraction conditions or not.

Preferably, the design data is created by giving a name to the structural element according to a predetermined naming rule; and the extraction section includes: a first extraction function for extracting the structural element using the four extraction conditions; a second extraction function for extracting a structural element given a predetermined name using the predetermined naming rule in creation of the design data; and second selection means for selecting one of the first extraction function and the second extraction function.

Preferably, the extraction apparatus is used in a system capable of carrying out first data processing for converting structural elements extracted by the extraction section into the raster data according to kinds thereof, compressing the raster data, and rearranging the raster data based on position information of the structural elements detected by analyzing the design data, and second data processing for converting the design data into the raster data without performing extraction of the structural elements and compressing the raster data; and the extraction apparatus further comprises estimation means for estimating a time required for the first data processing and a time required for the second data processing and performs extraction of the structural elements when a result of estimation by the estimation means shows that the time required for the first data processing is shorter than the time required for the second data processing.

Furthermore, a third embodiment of the first aspect according to the present invention provides an extraction apparatus comprising: an acquisition section for acquiring design data that has a hierarchical structure, is converted into raster data corresponding to drawing onto a substrate, and is created by giving a name to a structural element in accordance with a predetermined naming rule; and an extraction section for analyzing the design data acquired by the acquisition section to extract a structural element with a predetermined name, using the predetermined naming rules of structural elements composing the design data.

A fourth embodiment of the first aspect according to the present invention provides a program for causing a computer to execute processing for extracting, from design data that has a hierarchical structure and is converted into raster data corresponding to drawing onto a substrate, a structural element that composes the design data, is repeatedly described in one hierarchical layer, and satisfies at least one of four extraction conditions concerning a size of the structural element, a number of times of repetition of the structural element in an upper structural element upper than the structural element, a number of lower structural elements composing the structural element, and a depth of the one hierarchical layer in which the structural element exists.

In addition, in order to attain the second object described above, a first embodiment of a second aspect provides a drawing data creation method of creating drawing data corresponding to drawing onto a substrate by rasterizing design data in which an image to be drawn on the substrate is described in a vector form, the drawing data creation method comprising: a first step of extracting one or more first repeated structural elements, each being repeatedly described from structural elements composing the design data, separating the one or more first repeated structural elements from one or more first non-repeated structural elements, each being not repeatedly described, extracting layout information indicating a position of the extracted one or more first repeated structural elements on the substrate, and creating part data of the one or more first non-repeated structural elements through rasterizing; a second step of repeatedly performing, predetermined times, the step of further extracting, from one first repeated structural element of the extracted one or more first repeated structural elements, one or more repeated structural elements, each being repeatedly described, separating one or more repeated structural elements from one or more non-repeated structural elements, each being not repeatedly described, extracting layout information indicating a position of the further extracted one or more repeated structural elements on the substrate, and creating part data of the one or more non-repeated structural elements through rasterizing; a third step of creating part data of the remaining one or more repeated structural elements through rasterizing; and a fourth step of saving the part data and the layout information of respective structural elements and creating the drawing data based on the part data and the layout information of the respective structural elements.

Here, preferably, the second step is repeatedly performed until the further extraction of the one or more repeated structural elements becomes impossible.

It is preferable that the drawing data creation method further comprise, when the image to be drawn on the substrate is changed, a step of changing at least one of the part data and the layout information.

It is preferable that the drawing data creation method further comprise, when the image to be drawn on the substrate is changed, displaying the raster data of the drawing data, changing the displayed raster data of the drawing data in units of pixels, changing the part data including the changed pixels, and changing the displaying of the displayed raster data in accordance with the change.

Moreover, a second embodiment of the second aspect according to the present invention provides a drawing data creation apparatus for creating drawing data corresponding to drawing onto a substrate by rasterizing design data in which an image to be drawn on the substrate is described in a vector form, comprising: an extraction section for extracting one or more repeated structural elements, each being repeatedly described from among structural elements composing the design data, separating the one or more repeated structural elements from one or more non-repeated structural elements, each being not repeatedly described, extracting layout information showing a position of the extracted one or more repeated structural elements on the substrate, and performing, predetermined times, step of further extracting, from the extracted one or more repeated structural elements, one or more repeated structural elements, each being repeatedly described, separating the one or more repeated structural elements from one or more non-repeated structural elements, each being not repeatedly described, and extracting layout information indicating a position of the further extracted one or more repeated structural elements on the substrate; a rasterizing section for creating part data of the one or more non-repeated structural elements through rasterizing and, when any one or more repeated structural elements remain in the design data even after further extraction of the one or more repeated structural elements are performed predetermined times, creating part data of the remaining one or more repeated structural elements through rasterizing; a save section for saving the part data and the layout information of respective structural elements; and a layout synthesis section for creating the raster data of the drawing data corresponding to the drawing onto the substrate based on the part data and the layout information of the respective structural elements.

Here, it is preferable that the drawing data creation apparatus further comprise an edit section having a function for, when the image to be drawn on the substrate is changed, changing at least one of the part data and the layout information.

And, it is preferable that the drawing data creation apparatus further comprise: an edit layout synthesis section for creating the drawing data based on the part data and the layout information of the respective structural elements; a display section for displaying the raster data obtained by the edit layout synthesis section; and a change section having a function for changing the raster data obtained by the edit layout synthesis section in units of pixels, changing the part data including the changed pixels, and further changing the displaying by the display section based on the raster data.

According to the first aspect of the present invention having the structure described above, in data processing which is performed in an exposure system such as a drawing system for a substrate in manufacturing an LCD panel or the like, for creating digital mask data (drawing data) in order to generate data (image forming data such as exposure data) corresponding to image drawing onto a substrate in a drawing apparatus, e.g., image exposure onto a substrate in an exposure machine, from design data, when acceleration of the processing is aimed to achieve by regarding each structural element (data) that is repeatedly described on the design data as a part (data) and then the digital mask data is created by synthesizing the part, it becomes possible to automatically extract the structural element to be regarded as a part on the design data using a predetermined extraction condition.

Accordingly, according to the first aspect of the present invention, it becomes possible to reduce a burden on an operator operating a system and also to start processing for converting design data into raster data immediately after analysis of the design data is finished, so acceleration of generation of digital mask data is also achieved by eliminating an unnecessary time.

Further, according to the second aspect of the present invention, a first step comprises extracting each repeated structural element from structural elements composing design data, separating the repeated structural element from each non-repeated structural element, extracting layout information indicating each position of the repeated structural element on a substrate, creating part data of the non-repeated structural element by performing rasterizing, and extracting layout information indicating a position of the non-repeated structural element on the substrate; a second step repeatedly performs a series of operations predetermined times, the series of operations comprising extracting each further repeated structural element from the repeated structural element, separating the repeated structural element from each non-repeated structural element, extracting layout information showing each position of the further extracted repeated structural element on the substrate, and creating part data of the non-repeated structural element by performing rasterizing; a third step creates part data of each remaining repeated structural element by performing rasterizing, and a fourth step saves the part data and the layout information of each structural element, based on which drawing data is generated, so when a substrate of a liquid crystal display or the like is designed and produced, when at the time of a design change, it becomes possible to change raster data that is drawing data corresponding to drawing onto the substrate by changing the part data or the layout information of the each structural element saved in the fourth step. Therefore, unlike in the conventional case, when a design change is made, it is unnecessary to perform rasterizing after design data is changed, which makes it possible to shorten a time required from the design change to re-formation of a changed image on a substrate.

As a result, it becomes possible to shorten a time required for trial production at the time of a product development and it becomes possible to shorten a period of time of the product development, to thereby introduce a new product early in the market. In addition, even when conversion accuracy at the time of conversion from design data into raster data is enhanced, an influence of a design change or the like on trial production is small, so it becomes possible to increase drawing accuracy of an image and improve quality of an obtained product.

### BRIEF DESCRIPTION OF THE DRAWINGS

In the accompanying drawings:

FIG. 1 is a block diagram conceptually showing an embodiment of a drawing system using an extraction apparatus of the present invention;

FIG. 2A is a schematic diagram conceptually showing an example of an image of a certain layer of LCD panels to be exposed on a substrate;

FIG. 2B is a schematic diagram showing an example (a part thereof) of a configuration of design data of the image shown in FIG. 2A;

FIGS. 3A and 3B are each a conceptual diagram for explanation of an example of structural element extraction according to the present invention;

FIG. 4 is a flowchart for explanation of an example of an action of the extraction apparatus of the present invention;

FIG. 5A is a diagram conceptually showing an example of an image of LCD panels to be exposed onto a substrate;

FIG. 5B is a schematic diagram showing an example of a configuration of design data of the image shown in FIG. 5A;

FIG. 6 is a block diagram showing an embodiment of a drawing system provided with a drawing data creation apparatus according to the present invention;

FIG. 7 is a schematic diagram showing an example of a structure of part data obtained from design data by the drawing data creation apparatus of the present invention;

FIG. 8A is a schematic diagram showing an example of a structure of the design data used in the drawing system of the embodiment of the present invention;

FIG. 8B is an enlarged diagram of a main portion of FIG. 8A;

FIG. 8C is a schematic diagram showing an example of the structure of the part data obtained from the design data;

FIG. 9A is a schematic diagram showing an example of a cell of a panel portion:

FIG. 9B is a schematic diagram showing an example of the cell of the panel portion after a change;

FIG. 9C is a schematic diagram showing a synthesized image obtained in an edit/layout/synthesis section of a data edit apparatus of the drawing system of the embodiment of the present invention; and

FIG. 9D is a schematic diagram enlargedly showing an example of a main portion of a panel portion of the synthesized image after the change.

### DETAILED DESCRIPTION OF THE PREFERRED EMBODIMENTS

Hereinafter, the extraction method, the extraction apparatus, the program, the drawing data creation method and the drawing data creation apparatus of the present invention will be described in detail based on a preferred embodiment illustrated in the accompanying drawings.

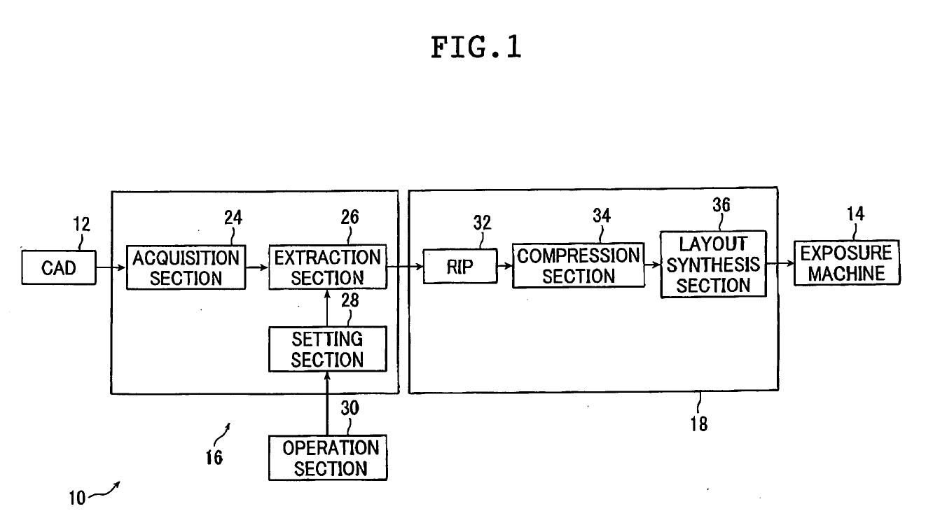

First, the extraction method, extraction apparatus and the program according to the first aspect of the present invention will be described with reference to FIGS. 1 to 5B.

FIG. 1 is a conceptual diagram showing an embodiment of a drawing system that uses the extraction apparatus of the present invention that implements the extraction method of the present invention. In the illustrated example, the drawing system is exemplified by an exposure system, in which an image forming data is generated from drawing data through a predetermined processing, exposure data is generated as image forming data from the drawing data in the drawing apparatus where an image is formed on a substrate in accordance with the image forming data, and an exposure machine, namely, a digital exposure machine, forms an image corresponding to the exposure data onto a substrate through exposure. However, the present invention is not limited thereto, and, as a matter of course, other image exposure apparatuses, thermal drawing apparatuses and inkjet drawing apparatuses, as well as the drawing system according to the second aspect of the present invention described later, may be used as the drawing apparatus.

A drawing system 10 shown in FIG. 1 is a system that, in manufacturing of an LCD panel, generates digital mask data (drawing data) for creating image data (exposure data) corresponding to image exposure (image drawing) on a substrate by an exposure machine 14 from design data of the LCD panel created by CAD 12, generates the exposure data by processing this digital mask data with the exposure machine 14, and performs the image exposure on the substrate (image recording target medium), and includes an extraction apparatus 16 and a digital mask data generation apparatus (hereinafter, referred to as the “mask data generation apparatus”) 18 of the present invention in addition to the CAD 12 and the exposure machine 14 described above.

It should be noted here that in the following description, the present invention will be explained by taking an example of manufacturing of an LCD panel but the present invention is not limited thereto and is preferably usable in creation of digital mask data in manufacturing of various products such as various semiconductor devices like a CPU and various memories, an integrated circuit for a portable telephone, and a printed wiring board.

The CAD 12 is a known computer-aided design (CAD) system that is used in design of an LCD panel, LSI, or the like.

In the drawing system 10 in the illustrated example, the CAD 12 designs an LCD panel using a known design tool or the like, creates design data corresponding to image exposure (drawing) in the exposure machine 14 by arranging (laying out) data of the designed LCD panel in accordance with a size of a substrate to be exposed by the exposure machine 14 (substrate on which an image of the designed LCD panel is to be exposed), and supplies the design data to the extraction apparatus 16 of the present invention.

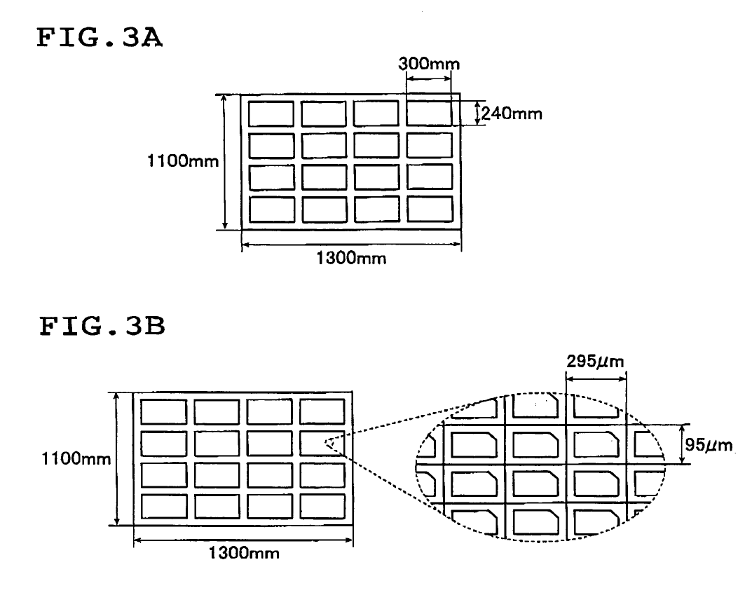

For instance, when an LCD panel of 15 inches (300×240 mm) is manufactured using a substrate (1300×1100 mm) of G5 (fifth generation) with the exposure machine 14, it is sufficient that, as conceptually shown in FIGS. 3A and 3B, design data in which 16 (pieces of data of) LCD panels are arranged in four columns and four rows is created while a long-side direction and a short-side direction of the substrate and those of the LCD panel are aligned with each other. When LCD panels of 50 inches are manufactured using a substrate (2200×2400 mm) of G8 (eighth generation) with the exposure machine 14, it is sufficient that design data in which 6 (pieces of data of) LCD panels are arranged in two columns and three rows is created while a long-side direction and a short-side direction of the substrate and those of the LCD panel are aligned with each other.

There is no specific limitation on the design data created with the CAD 12, in other words, the design data processed by the extraction apparatus 16 of the present invention and every design data of a semiconductor device based on a known data format such as GDI II, GDS II, ODB++ or RS247X is usable. As already mentioned, the design data is ordinarily described with vectors (image data in a vector form).

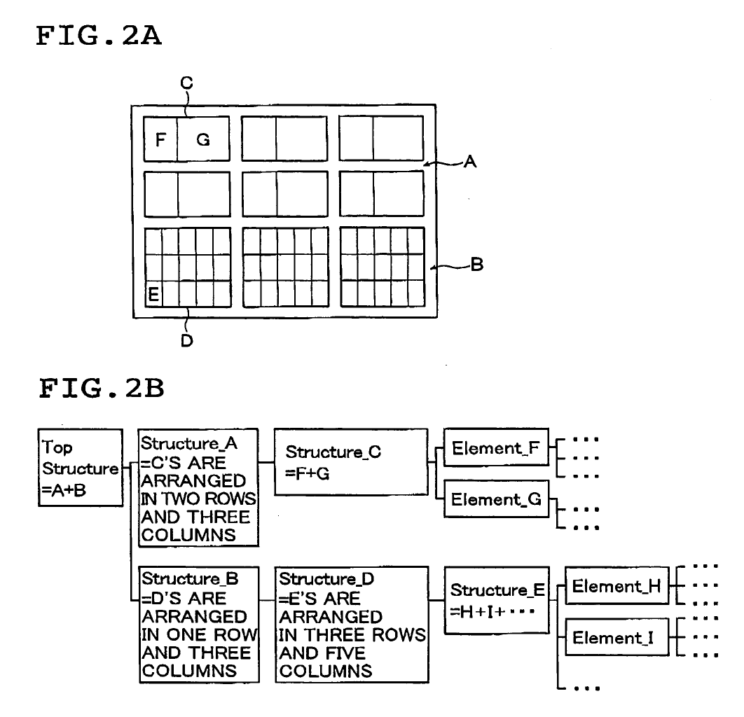

Also, as shown in FIGS. 2A and 2B, the design data created with the CAD 12, in other words, the design data processed by the extraction apparatus 16 of the present invention may include design data of multiple kinds of LCD panels such as LCD panels having different sizes or LCD panels in different specifications (design data of multiple kinds of LCD panels may be described).

The extraction apparatus 16 is the extraction apparatus of the present invention that implements the extraction method of the present invention and includes, as schematically shown in FIG. 1, an acquisition section 24, an extraction section 26, a setting section 28, and an operation section 30.

The extraction apparatus 16 may be a computer such as a personal computer or a workstation. Also, in the drawing system 10, the extraction apparatus 16 and the digital mask generation apparatus 18 may be a single computer or different computers. In other words, the extraction apparatus of the present invention may include a function of the digital mask generation apparatus 18 (or a part thereof) to be described later.

The acquisition section 24 is a section for acquiring the design data created by the CAD 12 and supplying the acquired design data to the extraction section 26.

There is no specific limitation on the acquisition section 24 and known data acquisition means by a computer using an interface or the like may be used. Note that in the present invention, the acquisition of the design data is not limited to the acquisition from the CAD 12 and the design data may be acquired from various others (systems) such as various storage means including databases or communication networks.

The operation section 30 is known computer operation means such as a keyboard and a mouse.

The extraction section 26 is a section for analyzing the LCD panel design data created by the CAD 12 and acquired by the acquisition section 24, extracting each structural element satisfying a predetermined extraction condition from among various structural elements (various pieces of structural element data) composing the design data, and, further, generating information (layout information) showing each position of the extracted structural element on the substrate.

It should be noted here that the program of the present invention is a program for causing a computer to execute the structural element extraction action by this extraction section 26.

In manufacturing of a semiconductor device for an LCD panel or the like, when an image of a product corresponding to design data created with the CAD 12 or the like is exposed (drawn) on a substrate with the digital exposure machine, it is required to convert the design data into digital mask data for generating exposure data corresponding to the image exposure by the exposure machine.

Here, as a method of accelerating this conversion of the design data into the digital mask data, there is known a method disclosed in JP 2006-254190 A and JP 2006-251036 A in which multiple structural elements that exist in the design data (structural element repeatedly described on the design data) are regarded as a single part (a single part data) composing the design data, only one structural element is converted into raster data for the structural elements regarded as a part and, alternatively, is further compressed, and raster data corresponding to the digital mask data is held by possessing a piece of the raster data and position information (layout information) on the substrate for the structural elements.

Under present circumstances, however, a judgment as to which structural element is to be set as a part and designation of the structural element to be set as a part are made by an operator operating the system, so there is a case where a burden is placed on the operator and a longer time is required for the data conversion.

The extraction section 26 (extraction apparatus 16) is a section for solving such inconvenience and, as described above, analyzing the design data acquired by the acquisition section 24 and extracting, from among the structural elements composing the design data, each structural element satisfying the predetermined extraction condition as a part (hereinafter, this structural element extraction will be referred to as “part extraction” and the structural element extracted (to be extracted) as a part will be referred to as “part”).

Also, the extraction section 26 detects each position of a part on the substrate through analysis of the design data and creates layout information that is information showing this position of the part on the substrate.

In the present invention, the part extraction by the extraction section 26 is based on a necessary condition that the multiple structural elements are arranged in one hierarchical layer of the design data (repeatedly described in one hierarchical layer (structurally described)). In other words, the part extraction is performed by setting each structural element that is repeatedly described multiple times in one hierarchical layer as a candidate for a part.

The extraction section 26 extracts, as a part, each structural element that satisfies this fundamental condition as well as one or more of four extraction conditions concerning a size of the structural element that is a part candidate, the number of times of repetition of the structural element that is a part candidate in its upper hierarchical layer, the number of lower structural elements composing the structural element that is a part candidate, and a depth of a hierarchical layer in which the structural element that is a part candidate exists, in the design data.

As described above, the design data is based on a data format such as GDI II, GDS II, ODB++ or RS247X, has a hierarchical structure, and is described in a vector form.

FIG. 2A shows an image of a certain layer of LCD panels to be exposed onto the substrate in the exposure machine 14 and FIG. 2B shows an example (a part) of a structure of design data thereof.

As conceptually shown in FIG. 2A, in this example, on one substrate, six images of an LCD panel labeled “C” and three images of an LCD panel labeled “D” are exposed (drawn).

In the top hierarchical layer of the design data, it is described that this design data is composed of Structure_A and Structure_B.

Hierarchical layers below the top hierarchical layer are divided into two lines respectively corresponding to Structure_A and Structure_B.

In the line for Structure_A, first, it is described that Structure_A is made by arranging six Structure_C's (in other words, the LCD panels C) in two rows and three columns. In other words, Structure_C is repeatedly described six times.

Also, in its lower hierarchical layer, it is described that Structure_C is composed of element_F and element_G. Further, its lower hierarchical layers are divided into two lines, with a detailed structure of element_F being described in one of the lines and a detailed structure of element_G being described in the other of the lines.

On the other hand, in the other of the lines, first, in the second hierarchical layer, it is described that Structure_B is made by arranging three Structure_D's (in other words, the LCD panels D) in one row and three columns. In other words, Structure_D is repeatedly described three times.

In its lower hierarchical layer, it is described that Structure_D is made by arranging 15 Structure_E's in three rows and five columns. In other words, Structure_E is repeatedly described 15 times.

In its lower hierarchical layer, it is described that Structure_E is composed of element_H, element_I, and the like and, further, in its lower hierarchical layers, a detailed structure of each element is described.

The structural elements of the design data refer to respective elements, such as Structures and elements described in respective hierarchical layers, composing respective hierarchical layers, and are Structure_A to Structure_E, element_F to element_I, and the like in the example shown in FIG. 2B.

As described above, at the extraction section 26, each structural element that is repeatedly described in one hierarchical layer of the design data is set as a part candidate. In other words, each structural element that is repeatedly described in a upper hierarchical layer upper than the hierarchical layer in which the structural element is described, is set as a part candidate. Accordingly, in the example shown in FIG. 2B, Structure_C, Structure_D, and Structure_E each become a part candidate.

As described above, in the extraction section 26, each structural element satisfying the fundamental condition as well as at least one of the four extraction conditions described above is set as a part.

The first condition of the four extraction conditions described above concerns a size (dimension) of the structural element that is a part candidate. In other words, when a size of the structural element that is a part candidate to be image-exposed onto the substrate falls within a predetermined range, this structural element is extracted as a part.

The second condition of the extraction conditions concerns the number of structural elements to be arranged, in other words, the number of times of repetition of description of the structural element that is a part candidate in an upper hierarchical layer, and when the number of times of repetition of description in the upper layer falls within a predetermined range, this structural element is extracted as a part.

For instance, in the example shown in FIG. 2B, when the extraction condition is set to “extract each structural element that is repeated twice to ten times in an upper layer”, Structure_C and Structure_D each become a part.

The third condition of the extraction conditions concerns the number of lower structural elements composing the structural element that is a part candidate, and when the structural element that is a part candidate is composed of a number within a predetermined range of structural elements in a lower hierarchical layer, this structural element is extracted as a part.

For instance, in the example shown in FIG. 2B, when the extraction condition is set to “extract each structural element that is composed of two or more lower structural elements”, Structure_C, Structure_D, and Structure_E each become a part.

The fourth condition of the extraction conditions concerns a depth of a hierarchical layer, in which the structural element that is a part candidate is described, in the hierarchical structure of the design data.

For instance, in the example shown in FIG. 2B, when the extraction condition is set to “extract each structural element in up to the third hierarchical layer”, Structure_C and Structure_D each become a part. Alternatively, instead of being set to “extract each structural element in up to a given hierarchical layer (or from a given hierarchical layer to another given hierarchical layer)”, the extraction condition may be set to “extract each structural element in a given hierarchical layer”.

At the extraction section 26, only one of these four extraction conditions may be set. Alternatively, two to four of the extraction conditions may be set. Note that it is preferable that at least the extraction condition concerning the size of the structural element or the extraction condition concerning the number of times of repetition in the upper layer be set.

Also, when multiple extraction conditions are set, only when all of the extraction conditions are satisfied, the structural element that is a part candidate may be set as a part. Alternatively, when one or a predetermined number of the extraction conditions are satisfied, the structural element that is a part candidate may be extracted as a part.

Here, in the present invention, each part extraction condition and a satisfy/not-satisfy threshold value (pass/fail judgment threshold value) for the extraction condition in the extraction section 26 may be fixed.

However, in the present invention, it is preferable that, out of the four extraction conditions described above, at least the condition concerning the size of the structural element and the condition concerning the number of times of repetition in an upper hierarchical layer be set in the extraction apparatus 16 and it is further preferable that the operator (user of the drawing system 10) be allowed to select each extraction condition to be used and, further, determine a pass/fail judgment threshold value (hereinafter, referred to as “threshold value”) for the extraction condition.

The extraction apparatus 16 in the illustrated example corresponds to this and includes the setting section 28. The four extraction conditions described above are set in this setting section 28 and in accordance with an input/instruction by the operator using the operation section 30, the setting section 28 selects each extraction condition to be used in the extraction section 26, determines a threshold value for the condition, and sets the selected condition and the determined value in the extraction section 26.

It should be noted here that it is sufficient that the extraction condition selection and the threshold value input/instruction by the operator using the operation section 30 are performed by a known method using a Graphical User Interface (GUI) or the like.

Once a product to be manufactured and a size of a substrate (panel size) to be used in the exposure machine 14 are determined, it becomes possible to mostly find a size of each structural element composing the design data, the number of times of repetition of description, and the like, so when the extraction condition and the threshold value are selected and set in the extraction section 26 based on the found size, the number of times and the like, it becomes possible to extract each structural element that is appropriate as a part.

Here, it is preferable that in the part extraction, not only a processing time but also a design change and modification are taken into consideration. In addition, a case is also conceivable in which the part extraction condition is set in consideration for a size of each structural element having a possibility of a modification or a change. For instance, in LCD panel manufacturing, in a case where a design change or interchange in units of LCD panels is considered, when the LCD panels are set as parts, it becomes sufficient to change only design of each LCD panel that is a change target in design data, thereby making it possible to shorten a processing time at the time of the change. In other words, when the condition is fixed, a change of the design data is required but when it is possible to select the extraction condition and the threshold value in this manner, in the case of a part change, it becomes sufficient that each part that is a change target is designed again, which makes it possible to easily perform a part interchange or change within a short period of time.

Accordingly, like in the illustrated example, by making it possible to select/determine the extraction condition and the threshold value in accordance with an input/instruction by the operator, in other words, with such a construction that it is possible for the operator of the drawing system 10 or an LCD panel designer to appropriately set the extraction condition and the threshold value for setting a part, it becomes possible to obtain the extraction apparatus 16 that suitably responds to the user's demand and is highly convenient.

As an example, assumed that when 16 LCD panels of 15 inches (300×240 mm) are manufactured using a substrate of G5 (1300×1100 mm) as shown in FIG. 3A, an LCD panel is interchanged or a design change is made.

In this case, it is sufficient that the LCD panels are assumed as structural elements to be set as parts, so by selecting the extraction condition concerning the part size and/or the extraction condition concerning the number of times of repetition in the upper hierarchical layer in the design data, setting the threshold value for the part size to be in a range of 290×230 mm to 310×250 mm, and setting the threshold value for the number of times of repetition to be in a range of 15 to 17, becomes possible to extract the LCD panels as parts.

Also, when multiple kinds of LCD panels having different sizes are manufactured as shown in FIGS. 2A and 2B, by, in accordance with the sizes of the LCD panels to be produced, selecting the extraction condition concerning the structural element size and determining the threshold value to “extract each structural element having a given length or more”, it becomes possible to extract the LCD panels as parts.

Meanwhile, a case is assumed in which when 16 LCD panels of 15 inches are manufactured using a substrate of G5 in a like manner, a design modification is made in units of pixels.

When it is assumed that a resolution of the LCD panels is 1024×768, as schematically shown in FIG. 3B, a size of one pixel becomes around 295×95 μm and the number of pixels becomes 2359296 (1024×768×3). Accordingly, in this case, by assuming the pixels as the structural elements to be extracted as parts, selecting the extraction condition concerning the part size and/or the extraction condition concerning the number of times of repetition in the upper layer of the design data, setting the threshold value for the part size in a range of 290×90 μm to 300×100 μm, and setting the threshold value for the number of times of repetition in a range of 2300000 to 2400000, it becomes possible to extract the pixels as parts.

It should be noted here that the present invention is not limited to the construction in which both of the extraction conditions and the threshold values are selectable. In other words, the extraction conditions may be set fixed and only the threshold values can be set. Alternatively, the threshold values may be set fixed and only the extraction conditions may be made selectable.

Also, when the extraction conditions and the threshold values in the extraction section 26 are set fixed, it is sufficient that the extraction conditions and the threshold values are appropriately determined in accordance with a product to be manufactured with the exposure machine 14 and a size of a substrate to be used by the exposure machine 14.

Once the product to be manufactured is determined, it becomes possible to expect a size of each structural element in the design data. Also, once the size of the substrate and the product to be manufactured are determined, it becomes possible to predict the number of times of repetition of each structural element in an upper hierarchical layer in the design data. Further, once the product to be manufactured is determined, it becomes possible to expect the number of lower structural elements composing a certain structural element and a depth of a hierarchical layer of the structural element in the design data.

Accordingly, when the extraction conditions and the threshold values in the extraction section 26 are set fixed, by appropriately determining the extraction conditions to be used and the pass/fail threshold values in accordance with the product to be manufactured with the exposure machine 14 and the size of the substrate to be used by the exposure machine 14, it becomes possible to extract each structural element which is appropriate as a part.

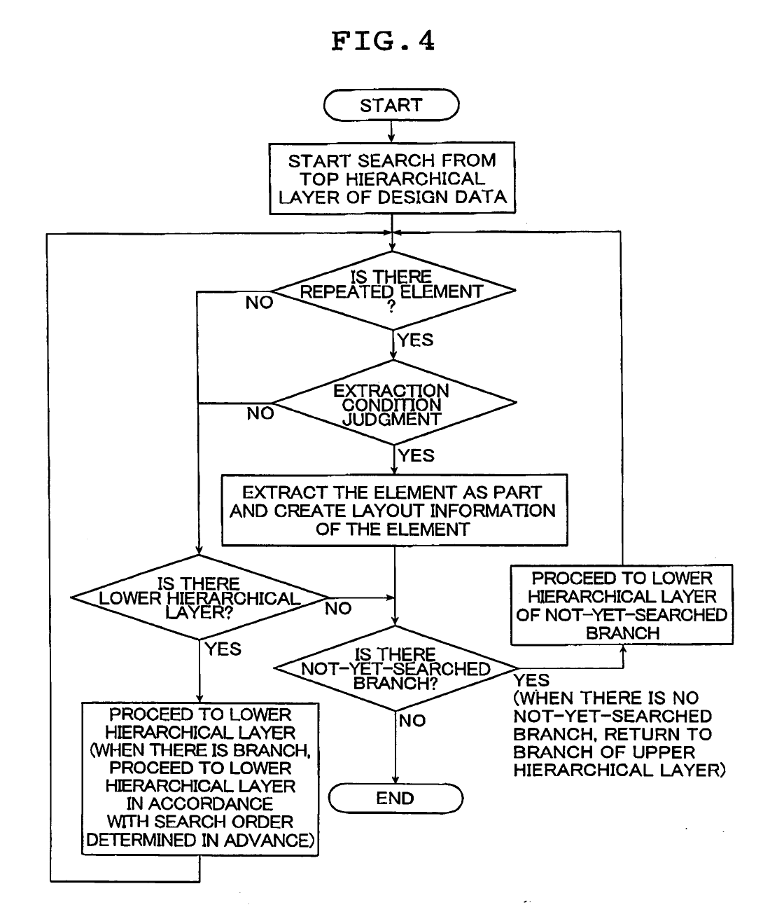

Hereinafter, a part extraction action in the extraction section 26 will be described with reference to a flowchart in FIG. 4.

First, a search is started from the top hierarchical layer of the design data and multiple structural elements (elements) that exist in a currently processed hierarchical layer, in other words, each structural element that is repeatedly described is detected.

When there is no element that is repeated in the hierarchical layer (NO), the presence or absence of a lower hierarchical layer is detected.

When it is found as a result of the detection that there is a lower hierarchical layer (YES), the processing proceeds to the lower hierarchical layer and the repeated element extraction processing is repeated. Note that when there is a branch in the design data, the processing proceeds to the lower hierarchical layer in accordance with a search order determined in advance.

On the other hand, when it is found that there is no lower hierarchical layer (NO), it is detected whether there is a not-yet-searched branch. When it is found as a result of the detection that there is no not-yet-searched branch (NO), the part extraction processing is ended. When there is a not-yet-searched branch (YES), the processing proceeds to a lower hierarchical layer below the not-yet-searched branch and the repeated element extraction is performed as in the above description. Note that in this not-yet-searched branch detection, when there is no not-yet-searched branch from an immediately upper hierarchical layer, the processing returns to a branch from a further upper hierarchical layer and the not-yet-searched branch detection is performed.

When a repeated structural element is extracted in a certain hierarchical layer (YES), the structural element is set as a part candidate and for the structural element, in accordance with the set extraction conditions and threshold values, a pass/fail judgment based on the threshold values for the part extraction conditions (=a satisfy/not-satisfy judgment, an extraction condition judgment) is made.

When it is found as a result of the extraction condition judgment that the part candidate does not satisfy the threshold values (NO), in other words, when a part that becomes a target of the extraction is not extracted, the presence or absence of a lower hierarchical layer is detected like in the above description. Following this, the same processing as above is performed.

On the other hand, when it is found as a result of the extraction condition judgment that the part candidate satisfies the threshold values for the extraction conditions (YES), the structural element is extracted as a part. In addition, for this structural element, layout information showing each position on the substrate to be exposed with the exposure machine is created.

After the part extraction and the layout information creation, like in the above description, it is detected whether there is a not-yet-searched branch and when there is a not-yet-searched branch (YES), like in the above description, the processing proceeds to a lower hierarchical layer below the not-yet-searched branch and the same processing is performed. When there is no branch (NO), the part extraction processing is ended.

Incidentally, among design tools for an LCD panel or the like used in the CAD 12, there are also many design tools having a function capable of giving names to the structural elements of the design data.

As a preferable mode, the extraction apparatus 16 in the illustrated example has a first extraction function for the part extraction using the four extraction conditions described above and a second extraction function for part extraction using the function of giving names to the structural elements of the design data.

In the drawing system 10 using the second extraction function, a design rule, in which, at a stage of designing an LCD panel (design data creation stage) by the CAD 12 or the like, a designer gives a unique identifier to each structural element to be extracted as a part, is set.

With the second extraction function, each structural element that satisfies the fundamental condition described above, which is a condition for setting each structural element that is repeatedly described in one hierarchical layer as a part candidate, is set as a part candidate and each structural element, to whose name a specific identifier is given, is extracted as a part.

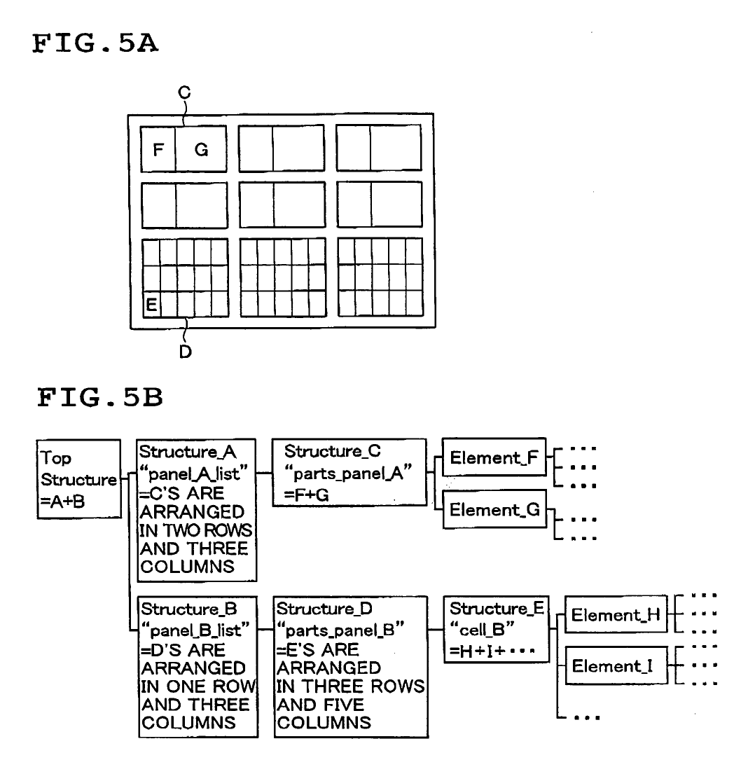

FIGS. 5A and 5B show an example of an image of a layer of an LCD panel based on design data corresponding to this part extraction using the naming function and a configuration of the design data.

Like the example shown in FIGS. 2A and 2B described above, in this example illustrated in FIGS. 5A and 5B, six images of an LCD panel labeled “C” and three images of an LCD panel labeled “D” are exposed (drawn) on one substrate. In other words, the image of a layer of an LCD panel to be exposed onto a substrate shown in FIG. 5A is identical to the image shown in FIG. 2A, and the configuration of the design data shown in FIG. 5B has a hierarchical structure similarly to the design data shown in FIG. 2B but is described in a different description form.

In addition, in this example, as shown in FIG. 5B, in the design data, an identifier “parts” is given to a start of each structural element that should be extracted as a part.

Like in the aforementioned example of FIG. 2B, in the top hierarchical layer, it is described that this design data is structured from Structure_A and Structure_B also in this example.

In a line for Structure_A, first, it is described that Structure_A is an arrangement of panel_A's and is structured by arranging six Structure_C's (in other words, the LCD panel C's) given the name “panel_A” in two rows and three columns.

In a lower hierarchical layer below the Structure_A, it is described that Structure_C given the name “panel_A” is composed of element_T and element_G. Here, in this design data, Structure_C having this designation “panel_A” is created so as to be set as a part and is indicated with a name “parts panel_A”.

Like in the above description, lower hierarchical layers below Structure_C are divided into two lines, with a detailed structure of element_F being described in one of the lines and a detailed structure of element_G being described in the other of the lines.

On the other hand, first, in the other of the lines in the second hierarchical layer, it is described that Structure_B is an arrangement of panel_B's and is structured by arranging three Structure_D's (in other words, the LCD panels D) given this name “panel_B” in one row and three columns.

In a lower hierarchical layer below this Structure_B, it is described that Structure_D given the name “panel_B” is composed of 15 Structure_E's arranged in three rows and five columns. Here, in this design data, panel_B composing this hierarchically layer is created so as to be set as a part and is indicated with a name “parts_panel_B”.

In a lower hierarchical layer below Structure_D, it is described that Structure_E is a structural element given a name “cell_B” and is composed of element_H, element_I, and the like. In the further lower hierarchical layer, a detailed structure of each element is described.

The extraction section 26 sets each structural element that is repeatedly described in one hierarchical layer of the design data as a part candidate, so, like in the above example, also in this example, Structure_C, Structure_D, and Structure_E each become a candidate for a structural element to be extracted as a part.

Also, with the second extraction function, each structural element, at the beginning of whose name the predetermined identifier “parts” is given, in the design data is extracted as a part. Accordingly, when the second extraction function is implemented, the extraction section 26 extracts each of Structure_C and Structure_D, at the beginning of whose names an identifier “parts” is given, as a part from among the part candidates.

In the illustrated example, this second extraction function is also set in the setting section 28, and the setting section 28 sets in the extraction section 26 either the first extraction function or the second extraction function that is selected in accordance with an input/instruction by the operator using the operation section 30.

Alternatively, in the extraction apparatus 16, the first extraction function may be set in the extraction section 26 as a default (ordinary specification) and only when the second extraction function is selected, the setting section 28 may set the second extraction function in the extraction section 26.

Also, as to the part extraction action by the second extraction function, fundamentally, it is sufficient that the extraction condition judgment is made based not on the extraction conditions and the threshold values but on the names of the structural elements in the flowchart shown in FIG. 4.

It should be noted here that the extraction apparatus 16 of the present invention is not limited to the construction having both of the first extraction function and the second extraction function so that switching between them is possible, and a construction which has either one of the first extraction function and the second extraction function is also possible.

A result of the part extraction by the extraction apparatus 16 and the layout information are sent to the mask data generation apparatus 18.

Here, although described in detail later, in the drawing system 10, fundamentally, after each part is extracted by the extraction apparatus 16, in the mask data generation apparatus 18, every part (vector data describing this part) is converted into raster data and is compressed. After that, digital mask data is generated by synthesizing an image through arrangement of the raster data in accordance with the layout information. This digital mask data is supplied to the exposure machine 14, at which data corresponding to exposure by an exposure head possessed by the exposure machine 14 is generated from the digital mask data by performing necessary data processing such as decompression and conversion, and exposure of a substrate is performed in accordance with this data.

In other words, when processing is performed by extracting each structural element that becomes a part from the design data, it becomes necessary to generate layout information and perform raster data arrangement (layout)/synthesis processing in accordance with the layout information.

Therefore, depending on the structural element to be extracted as a part (part extraction conditions and threshold values), there is also a case where a processing load is reduced and an overall processing time is shortened by converting the design data into raster data as it is without performing the part extraction.

In the illustrated example, as a preferable mode, the extraction apparatus 16 has processing time estimation means (not shown) for estimating a time (hereinafter, referred to as “first data processing time” for ease of explanation) required for processing from conversion of each part into raster data through compression of the raster data to arrangement/synthesizing of the raster data and a time (hereinafter, referred to as “second data processing time” for ease of explanation) required for processing in which design data is converted into raster data as it is without performing the part extraction and the raster data is compressed.

In the extraction apparatus 16, when the acquisition section 24 acquires the design data, this estimation means estimates the first data processing time and the second data processing time.

When it is found as a result of the estimation that the first data processing time is shorter than the second data processing time, the extraction apparatus 16 performs the part extraction, associates information about each extracted part, layout information, and the design data with one another to be sent to the mask data generation apparatus 18.

Conversely, when the first data processing time is longer than the second data processing time, the extraction apparatus 16 sends the design data to the mask data generation apparatus 18 as it is without performing the part extraction. Then, in the drawing system 10, the mask data generation apparatus 18 converts the design data into raster data as it is and compresses the raster data (second data processing).

With this construction, in creation processing of the digital mask data from the design data, it becomes possible to selectively perform processing with higher efficiency.

Alternatively, when the first data processing time is longer than the second data processing time, the extraction apparatus 16 may issue a warning by displaying an alarm on a screen or making a warning sound to thereby perform selection/setting of the extraction condition and/or threshold value by the operation section 30 again.

After extracting each part from the design data and generating the layout information in this manner, the extraction section 26 (extraction apparatus 16) associates the information about each structural element extracted as a part, the layout information for the structural element, and the design data with one anther and sends them to the mask data generation apparatus 18.

The mask data generation apparatus 18 includes a rasterizing section 32 (raster image processor (RIP) 32), a compression section 34, and a layout synthesis section 36.

This mask data generation apparatus 18 generates digital mask data (drawing data) corresponding to an image to be exposed on a substrate by converting the design data described with vectors into raster data (bitmap data) in the RIP 32, compressing the raster data at the compression section 34, and further performing synthesis of each raster data in the layout synthesis section 36 and supplies the generated digital mask data to the exposure machine 14.

The RIP 32 converts (develops) the design data described with vectors into raster data.

In this case, in the drawing system 10, in the extraction apparatus 16, each structural element satisfying the specific condition is extracted as a part. The RIP 32 converts only one structural element extracted as a part at the extraction apparatus 16 into raster data, associates this raster data and the layout information supplied from the extraction apparatus 16 with each other, and sends them to the compression section 34.

It should be noted that all of the structural elements described in the design data are not necessarily extracted as parts, and there are also structural elements that are not extracted as parts. The RIP 32 collectively converts the structural elements (hereinafter, referred to as “remaining structural elements” for ease of explanation) that are not extracted as parts into one piece of raster data, further generates layout information for the structural elements, associates the raster data and the layout information with each other, and sends them to the compression section 34 together with the part raster data described above and the like.

In other words, in the drawing system 10, as in the case of the apparatuses disclosed in JP 2006-254190 A and JP 2006-251036 A, it is sufficient that only one structural element extracted as a part is converted into raster data and the raster data is compressed, so in processing for converting design data into digital mask data, it becomes possible to significantly shorten a time required for conversion into raster data and compression of the raster data, which take the longest time.

In addition, each structural element to be set as a part is automatically extracted in the extraction apparatus 16, so it becomes possible to start part extraction processing without a burden on the operator without delay, which enables swift processing.

It is sufficient that the conversion of the design data described with vectors into the raster data in the RIP 32 is performed by a known method performed by various RIPs.

It should be noted that when the extraction apparatus 16 does not perform the part extraction in accordance with the processing time of the first data processing and the second data processing estimated by the estimation means, the RIP 18 converts the design data into the raster data as it is (second data processing). In other words, in this case, this compressed raster data becomes image data corresponding to digital mask data.

The raster data obtained as a result of the conversion in the RIP 32 and the layout information are sent to the compression section 34.

The compression section 34 compresses the raster data of each part or raster data of each remaining structural element as well as the raster data of the part and supplies each raster data and layout information to the layout synthesis section 36. Note that it is sufficient that the compression of the raster data in the compression section 34 is performed by a known method such as run-length compression.

After receiving the raster data and the layout information, the layout synthesis section 36 generates digital mask data corresponding to an image to be exposed on a substrate by synthesizing the raster data, in other words, the image through arrangement (layout) of the compressed raster data of each part (structural element extracted as a part) in accordance with the layout information for the part, or further through arrangement of the compressed raster data of each remaining structural element in accordance with the layout information for the remaining structural element as well as the arrangement of the compressed raster data of the part. Then, the layout synthesis section 36 transfers the generated digital mask data to the exposure machine 14.

It should be noted that, as a matter of course, when the extraction apparatus 16 does not perform the part extraction described above, this layout synthesis processing in the layout synthesis section 36 is not required.

Also, it is preferable that the compressed raster data and the layout information supplied to the layout synthesis section 36 be saved as intermediate data with consideration given to re-generation of the digital mask data due to a design change or modification.

The exposure machine 14 generates exposure data that is data corresponding to image exposure on a substrate by itself, in other words, image exposure by an exposure head of itself by performing predetermined processing such as decompression on the digital mask data supplied from the mask data generation apparatus (layout synthesis section 36).

In addition, the exposure machine 14 records an image by imagewisely exposing the substrate (image recording target medium such as a substrate obtained by forming a photoresist layer on an insulation layer, a conductor layer, an Si layer) with recording light modulated in accordance with the exposure data generated from the digital mask data.

It should be noted that there is no specific limitation on a substrate exposure in the exposure machine 14 and various known substrate (photosensitive material) image exposure methods by recording light are usable. For instance, the exposure machine 14 may be a machine that exposes the image on the substrate by bringing recording light modulated in accordance with the exposure data into incident on the substrate using a two-dimensional spatial modulator such as a digital micromirror device (DMD), and relatively moving the substrate and an optical system in a direction orthogonal to a scanning line defined by the two-dimensional spatial modulator. Alternatively, the exposure machine 14 may be a machine that exposes the image on the substrate by deflecting a light beam modulated in accordance with the exposure data in a main-scanning direction and scanning/transporting the substrate (or moving an optical system) in a direction orthogonal to the main-scanning direction.

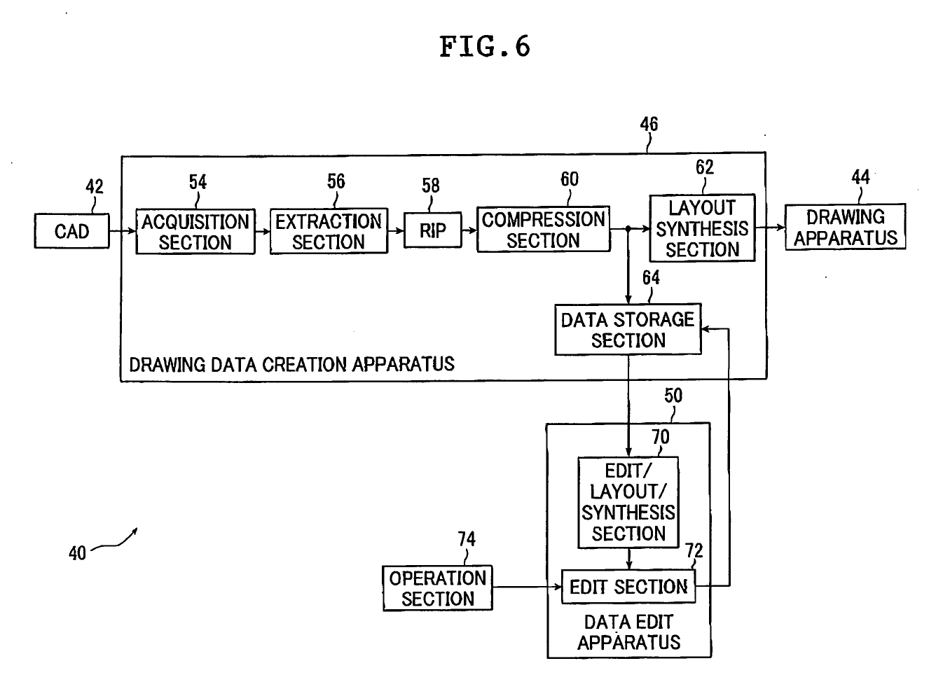

Next, with reference to FIGS. 6 to 9D, the drawing data creation method and the drawing data creation apparatus in the second aspect of the present invention will be described.

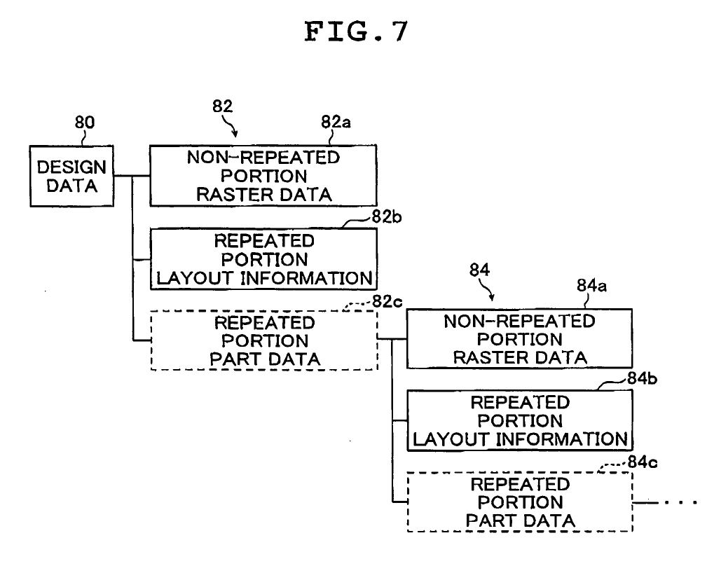

FIG. 6 is a block diagram showing an example of a drawing system provided with a drawing data creation apparatus according to a second embodiment in the second aspect of the present invention. FIG. 7 is a schematic diagram showing an example of a structure of part data obtained from design data by the drawing data creation apparatus according to the second embodiment in the second aspect of the present invention.

A drawing system 40 shown in FIG. 6 is a system that, in manufacturing an LCD panel, for example, generates drawing data for creating drawing formation data corresponding to image drawing on a substrate by a drawing apparatus 44 from design data of the LCD panel created by CAD 42, creates the draw (image) forming data by processing this drawing data and performing the image exposure on the substrate as image drawing with the drawing apparatus 44, and includes a drawing data creation apparatus 46 and a data edit apparatus 50 of the present invention in addition to the CAD 42 and the drawing apparatus 44 described above.

Note that the drawing system 40 shown in FIG. 6 includes some elements with similar configurations to those included in the drawing system 10 shown in FIG. 1, and detailed description of such the similar elements is omitted and mainly the elements with a unique configuration in the drawing system 40 are described below.

Similarly to the CAD 12 in FIG. 1, the CAD 42 is a known computer-aided design (CAD) system that is used in designing an LCD panel, LSI, or the like.

In the drawing system 40 in the illustrated example, the CAD 42 designs an LCD panel using a known design tool or the like, creates design data corresponding to image drawing (image exposure) in the drawing apparatus 44 by arranging (laying out) data of the designed LCD panel in accordance with a size of a substrate to be subjected to drawing by the drawing apparatus 44 (for example, substrate on which an image of the designed LCD panel is exposed), and supplies the design data to the drawing data creation apparatus 46 of the present invention.

For instance, when an LCD panel of 50 inches is manufactured using a substrate (2,200×2,400 mm) of G8 (eighth generation) or of 15 inches using a substrate (1300×1100 mm) of G5 (fifth generation) with the drawing apparatus 44, it is sufficient that design data is created in which a total of six (pieces of data of) LCD panels are arranged in three columns and two rows or a total of 16 (pieces of data of) LCD panels in four columns and four rows while a long-side direction and a short-side direction of the substrate and those of the LCD panel are aligned with each other.

There is no specific limitation on the design data created with the CAD 42, in other words, the design data processed by the drawing data creation apparatus 46 of the present invention and every design data of a semiconductor device based on a known data format such as GDI II, GDI II, ODB++ or RS247X is usable, similarly in the case of the CAD 12 shown in FIG. 1. As already mentioned, the design data is ordinarily data described with vectors (image data in a vector form).

Also, the design data created with the CAD 42, in other words, the design data processed by the drawing data creation apparatus 46 of the present invention may include design data of multiple kinds of LCD panels such as LCD panels having different sizes or LCD panels in different specifications.

The drawing apparatus 44 generates image forming data from drawing data which is supplied from the drawing data creation apparatus 46 corresponding to image drawing onto a substrate by performing predetermined processing such as decompression, and forms an image on the substrate in accordance with this image forming data.

Like the exposure machine 14 in FIG. 1, this drawing apparatus 44 is, for instance, an apparatus that generates exposure data from the drawing data by performing predetermined processing such as decompression, and forms the image on the substrate (for example, substrate obtained by forming a photoresist layer or a dry film resist film (DFR film) on an insulation layer, a conductor layer, an Si layer, or the like) by imagewisely exposing the substrate with recording light modulated in accordance with the exposure data. This drawing apparatus 44 is, for instance, a digital exposure machine used as the exposure machine 14 in FIG. 1.

It should be noted that the drawing apparatus 44 is not specifically limited, and in addition to the digital exposure machine, various other image exposure apparatuses are usable.

For instance, the drawing apparatus 44 may be an image exposure apparatus that exposes the image on the substrate by having recording light modulated in accordance with the image forming data (exposure data) incident on the substrate using a two-dimensional spatial modulator such as a digital micromirror device (DMD), and relatively moving the substrate and an optical system in a direction orthogonal to a scanning line defined by the two-dimensional spatial modulator. Alternatively, the drawing apparatus 44 may be an image exposure apparatus that exposes the image on the substrate by deflecting a light beam modulated in accordance with the image forming data (exposure data) in a main-scanning direction and scanning/transporting the substrate or moving an optical system in a direction orthogonal to the main-scanning direction.

Also, the drawing apparatus 44 is not limited to the image exposure apparatuses, and an apparatus of a thermal type or an inkjet type may be used. For instance, using an apparatus of an inkjet type as the drawing apparatus 44, an insulation layer or a wiring layer may be directly formed on the substrate based on the image forming data.

Also, the drawing data creation apparatus 46 of this embodiment is the drawing data creation apparatus of the present invention that implements the drawing data creation method of the present invention, and includes, as shown in FIG. 6, an acquisition section 54, an extraction section 56, a rasterizing section 58 (raster image processor (RIP) 58), a compression section 60, a layout synthesis section 62, and a data storage section (save section) 64.

It is sufficient that this drawing data creation apparatus 46 is composed of a computer such as a personal computer or a workstation.

The acquisition section 54 has the same configuration as that of the acquisition section 24 shown in FIG. 1 and acquires design data created by the CAD 42 and supplies the design data to the extraction section 56.

The extraction section 56 analyzes the LCD panel design data created by the CAD 42 and acquired by the acquisition section 54 and extracts, from various structural elements composing the design data, each structural element repeatedly described in the design data as a repeated structural element based on a condition that the structural element is repeatedly described in the design data, in other words, the structural element is arranged multiple times. In this manner, the extraction section 56 separates the repeated structural element from other structural elements than the repeated structural element that is repeatedly described, in other words, from non-repeated structural elements that are not repeatedly described.

In addition, the extraction section 56 extracts layout information indicating each position of the structural element extracted from the design data on the substrate.

Note that the extraction section 56 may include an extraction function for extracting a repeated structural element like the extraction function of the extraction section 26 shown in FIG. 1. In addition, the acquisition section 54 and the extraction section 56 may compose an extraction apparatus similarly to the extraction apparatus 16 composed of the acquisition section 24 and the extraction section 26 as shown in FIG. 1.

The RIP 58 is connected to the extraction section 56, and converts (develops) the design data outputted from the extraction section 56 and described in a vector form into raster data.

In this embodiment, as will be described later, the RIP 58 rasterizes the non-repeated structural element in the design data to create part data of raster data. Also, when the repeated structural element extraction is performed predetermined times and there remain any repeated structural elements, the RIP 58 rasterizes the remaining repeated structural elements to thereby obtain part data thereof. In this manner, the RIP 58 obtains the part data by, for instance, hierarchically converting the design data into parts.

It is sufficient that the conversion from the design data described with vectors into the raster data in the RIP 58 is performed by a known method performed by various RIPs.

It is needless to say that the RIP 58 may include the conversion (development) function similarly to that of the RIP 32 shown in FIG. 1.

The compression section 60 is a section for obtaining compressed part data (compressed raster data) by performing compression processing on the part data (raster data) obtained by the RIP 58, and with this compression section 60, it becomes possible to reduce a data amount.

Also, the compression section 60 is connected to the layout synthesis section 62 and the data storage section 64 and outputs the raster data after the compression processing to the layout synthesis section 62 and the data storage section 64. Note that it is sufficient that the compression of the raster data in the compression section 60 is performed by a known method such as run-length compression.

It is needless to say that the compression section 60 may include the compression processing function similar to that of the compression section 34 shown in FIG. 1. And, the RIP 58, the compression section 60, and the layout synthesis section 62 to be described later may compose a digital mask data generation apparatus like the digital mask data generation apparatus 18 composed of the RIP 32, the compression section 34, and the layout synthesis section 36 shown in FIG. 1.

The data storage section 64 saves the compressed raster data (part data) and the layout information supplied from the compression section 60 to the layout synthesis section 62 as intermediate data with consideration given to re-generation of drawing data due to a design change or modification.

This data storage section 64 includes various recording media such as a semiconductor memory and a hard disk, and the compressed raster data (part data) and the layout information supplied from the compression section 60 to the layout synthesis section 62 are saved as intermediate data in the various recording media.

In manufacturing a semiconductor device such as an LCD panel, when an image of a product corresponding to the design data created by the CAD 42 or the like is exposed (drawn) on a substrate with a digital exposure machine or the like, it is necessary to convert the design data into drawing data for generating exposure data (image forming data) corresponding to the image exposure by the digital exposure machine.

In this embodiment, by the extraction section 56 and the RIP 58, the part data is hierarchically created from the design data, and the structural elements of the design data are converted into parts. In other words, every structural element of the design data is converted into raster data.

By the extraction section 56 and the RIP 58 of this embodiment, as shown in FIG. 7, design data 80 is analyzed and part data 82 and 84 are each hierarchically created.

In the extraction section 56 of this embodiment, each repeated portion (repeated structural element) that is repeatedly described is extracted from structural elements composing the design data 80 to separate the repeated portion from each portion other than the repeated portion that is repeatedly described, in other words, each non-repeated portion (non-repeated structural element) that is not repeatedly described in the design data 80.

For the non-repeated portion, data, out of the design data 80, which corresponds to the non-repeated portion is outputted to the RIP 58, and then non-repeated portion raster data 82a (part data) is obtained by performing rasterizing.

On the other hand, for the repeated portion, layout information 82b indicating each position of part data 82c of the repeated portion on the substrate is extracted from the design data 80. Note that the repeated portion part data 82c is a collection of non-repeated portion raster data 82a (part data), layout information 84b, and repeated portion part data 84c to be described later.

The repeated portion part data 82c composing the repeated portion is further separated into repeated portion and non-repeated portion again.

For the non-repeated portion, data, out of the design data 80, which corresponds to the non-repeated portion is outputted to the RIP 58, and then the non-repeated portion raster data 84a (part data) is obtained by performing rasterizing.

On the other hand, for the repeated portion, the layout information 84b of the repeated portion part data 84c is extracted from the design data 80.

The repeated portion part data 84c is further separated into repeated portion and non-repeated portion again. Then, for the repeated portion, layout information is extracted from the design data 80 and for the non-repeated portion, corresponding design data is outputted to the RIP 58 and is rasterized to thereby obtain raster data (part data) of the non-repeated portion.

In this manner, in the extraction section 56 and the RIP 58 of this embodiment, extraction of the repeated portion and rasterizing of the non-repeated portion are repeatedly performed until further extraction of the repeated portion from the design data 80 becomes impossible. As a result, for the non-repeated portion, rasterizing is performed and the non-repeated portion raster data 82a and 84a (part data) are obtained. Further, by repeatedly performing extraction of the repeated portion predetermined times until further extraction of the repeated portion from the repeated portion part data 84c becomes impossible, raster data (part data) of non-repeated portion separated as a result of the extraction and raster data (part data) of structural element remaining when further extraction of the repeated portion becomes impossible are obtained. For the repeated portion, part information to which layout information is added is obtained. Ultimately, every structural element of the design data 80 is converted into raster data.

It should be noted that it is not necessarily required to perform the extraction of the repeated portion on the design data 80 until further extraction of the repeated portion becomes impossible and it is possible to appropriately change the number of times of the extraction of the repeated portion, in other words, a degree of conversion into hierarchical layers in accordance with a processing capability, a processing time, required product working accuracy, or the like.

Also, the non-repeated portion raster data 82a and 84a created in the RIP 58 are sent to the compression section 60 and the data storage section 64. Further, for the repeated portion, when the extraction of the repeated portion is interrupted at a stage of the repeated portion part data indicated with reference numeral “84c” and the repeated portion part data 84c is also rasterized, repeated portion raster data and layout information are also sent to the compression section 60 after being associated with each other.

In this compression section 60, the non-repeated portion raster data 82a and 84a and the repeated portion part data 84c created in the RIP 58 are compressed. Then, the non-repeated portion raster data 82a and 84a, the repeated portion part data 84c, and the layout information 82b and 84b are supplied from the compression section 60 to the layout synthesis section 62.

The layout synthesis section 62 creates drawing data (raster data) of an image to be drawn on a substrate by arranging (laying out) the compressed non-repeated portion raster data 82a and 84a (part data) and repeated portion part data 84c (part data) in accordance with the compressed non-repeated portion raster data 82a and 84a, repeated portion part data 84c, and layout information 82b and 84b, and transfers the drawing data to the drawing apparatus 44. In other words, the layout synthesis section 62 generates the drawing data (digital mask data) of the image to be drawn on the substrate by synthesizing the non-repeated portion raster data 82a and 84a and the repeated portion part data 84c and transfers the drawing data to the drawing apparatus 44.

Also, in the data storage section 64, the non-repeated portion raster data 82a and 84a, repeated portion part data 84c, and layout information 82b and 84b created in the RIP 58 are saved as intermediate data.

The data edit apparatus 50 includes an edit/layout/synthesis section 70 and an edit section 72, with an operation section 74 being connected to this edit section 72. A data edit section 20 is, for instance, composed of a computer such as a personal computer or a workstation, and the operation section 74 is known computer operation means such as a keyboard and a mouse.

The edit/layout/synthesis section 70 has the same function as the layout synthesis section 62 and generates the drawing data (digital mask data) of the image to be drawn on the substrate by synthesizing the non-repeated portion raster data 82a and 84a and the repeated portion part data 84c through arrangement of the non-repeated portion raster data 82a and 84a and the repeated portion part data 84c based on the respective layout information 82b and 84b.

The edit portion 72 has a function of changing the non-repeated portion raster data 82a and 84a and the repeated portion part data 84c in units of bits (pixels (picture elements)) and also has a function of changing the layout information.

This edit section 72 includes a display section (not shown) for displaying the drawing data obtained in the edit/layout/synthesis section 70 as a synthesis image in a manner described later and also has a function of displaying an enlarged or reduced synthesis image of the drawing data. This drawing data is displayed as bitmap data on the display section.

The edit section 72 is capable of allowing an operator to change the drawing data (bitmap data) displayed on the display section in units of bits (pixels (picture elements)) using the operation section 74 and is also capable of changing the layout information.

Also, when a portion in the drawing data changed by the edit section 72 is a repeated portion, part data of the repeated portion saved in the data storage portion 64 is changed, and every display of the repeated portion on the display section is also changed.

It should be noted that each part changed using the operation section 74 is saved in the data storage section 64 in a changed state.

Next, a drawing data creation method and a drawing method by the drawing system 40 of this embodiment will be described.

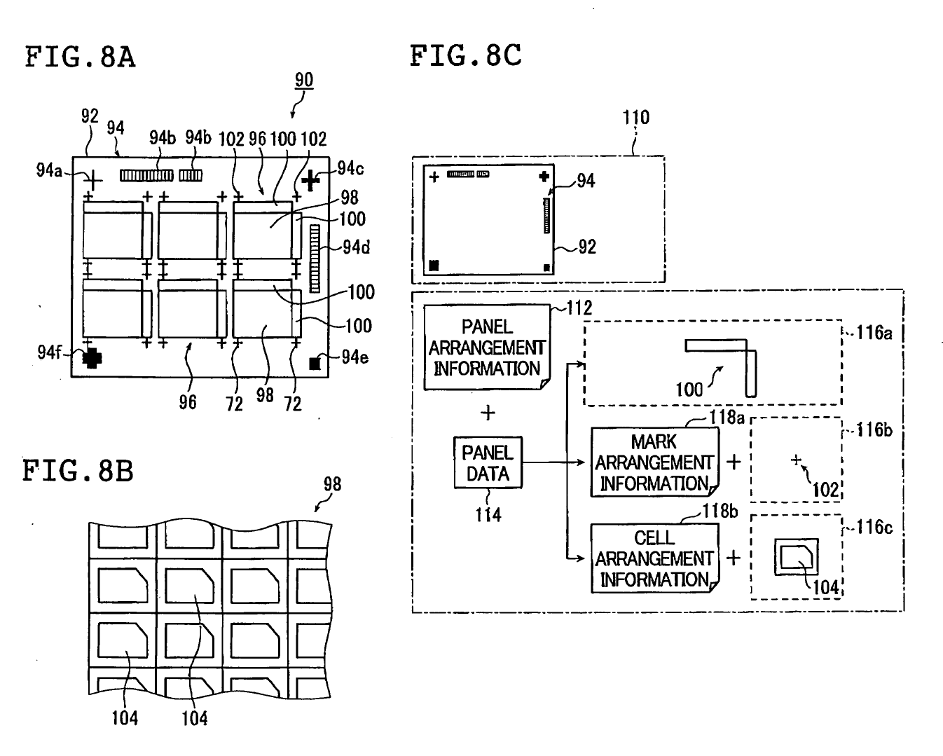

FIG. 8A is a schematic diagram showing a structure of design data used in the drawing system of this embodiment, FIG. 8B is an enlarged view of a main portion of FIG. 8A, and FIG. 8C is a schematic diagram showing a structure of part data obtained from the design data.

In this embodiment, a case where six LCD panels are formed on one substrate will be described as an example. In this case, in the CAD 42, as shown in FIG. 8A, design data 90 is created.

In this design data 90, on the margin of a substrate area 92, accessories 94 including alignment marks 94a, 94c, 94e, and 94f and lines and spaces (L/Ss) 94b and 94d are arranged.

The alignment marks 94a, 94c, 94e, and 94f are used to position the drawing apparatus 44 at the time of image formation. The lines and spaces (L/Ss) 94b and 94d are used to verify an exposure state by the drawing apparatus 44.

Each LCD panel portion 96 that ultimately becomes an LCD panel includes a display panel portion 98 and a wiring portion 100, and marks 102 for positioning are provided at four corners surrounding the each LCD panel portion 96, respectively. Also, as shown in FIG. 8B, the display panel portion 98 includes multiple cells 104 having the same shape. By the CAD 42, the design data 90 having the structure described above is created.

In the drawing data creation method by the drawing system 40 of this embodiment, first, the design data 90 is acquired from the CAD 42 by the acquisition section 54 and is outputted to the extraction section 56.

Next, in the extraction section 56, the design data 90 is separated into a repeated portion (repeated structural element) and an non-repeated portion (non-repeated structural element).

For instance, in the design data 90, the alignment marks 94a, 94c, 94e, and 94f and the lines and spaces (L/Ss) 94b and 94d of the accessories 94 are each formed only once, which means that there are no duplicates of the accessories 94. Therefore, the accessories 94 correspond to a non-repeated portion. Consequently, of the design data 90, data of the accessories 94 is outputted to the RIP 58 and is converted into raster data to thereby create part data 110 of the accessories 94.

On the other hand, in the design data 90, six LCD panel portions 96 are formed, which means that this portion 96 corresponds to a repeated portion. Therefore, panel arrangement information (layout information) indicating each position of the LCD panel portion 96 in the substrate area 92 is extracted without performing rasterizing.

Next, extraction of the repeated portion is further performed for the LCD panel portion 96 (repeated portion part data) to thereby separate the LCD panel portion 96 into a repeated portion and a non-repeated portion.

In this case, in the LCD panel portion 96, there is formed only one wiring portion 100 and no repeated portion is included, which means that this portion 100 corresponds to a non-repeated portion. Therefore, of the design data 90, data of the wiring portion 100 is outputted to the RIP 58 and is converted into raster data to thereby create part data 116a of the wiring portion 100.

Also, in the LCD panel portion 96, multiple marks 102 are formed and therefore correspond to a repeated portion. For each mark 102, mark arrangement information 118a (layout information) showing each position of the mark 102 is extracted from the design data 90.

Further, when the mark 102 is separated into a repeated portion and a non-repeated portion, the mark 102 includes no repeated portion, so the mark 102 itself becomes a non-repeated portion. Therefore, of the design data 90, data of the mark 102 is outputted to the RIP 58 and is converted into raster data to thereby create part data 116b of the mark 102.

Still further, when the display panel portion 98 is separated into a repeated portion and a non-repeated portion, the display panel portion 98 is composed by arranging multiple cells 104, so the cells 104 correspond to a repeated portion.

For each cell 104, cell arrangement information 118b (layout information) showing each position of the cell 104 is extracted from the design data 90.

Also, when the cell 104 is separated into a repeated portion and a non-repeated portion, the cell 104 includes no repeated portion, so the cell 104 itself becomes a non-repeated portion. Consequently, of the design data 90, data of the cell 104 is outputted to the RIP 58 and is converted into raster data to thereby obtain part data 116c of the cell 104.

In this manner, every structural element of the LCD panel design data 90 is converted into raster data, in other words, is rasterized and for the design data 90, the part data 110 of the accessories 94, the panel arrangement information 112, and as the panel data 114, the part data 116a of the wiring portion 100, the part data 116b and the mark arrangement information 118a of the mark 102, and the part data 116c and the cell arrangement information 118b of the cell 104 are hierarchically obtained. Those part data 110 and 116a to 116c, panel arrangement information 112, mark arrangement information 118a, and cell arrangement information 118b are outputted to the compression section 60 and compressed. Then, the compressed data and information are outputted from the compression section 60 to the layout synthesis section 62 and are also saved in the data storage section 64 as intermediate data.

Next, in the layout synthesis section 62, based on the part data 110 of the accessories 94, the panel arrangement information 112, the part data 116a of the wiring portion 100, the part data 116b and the mark arrangement information 118a of the mark 102, and the part data 116c and the cell arrangement information 118b of the cell 104, each part data is synthesized to thereby generate drawing data corresponding to an image to be exposed (drawn) on a substrate. Then, this drawing data is transferred to the drawing apparatus 44.

Next, image forming data is generated, in other words, image forming data is created from the drawing data which is supplied from the drawing data creation apparatus 46 and corresponds to the image drawing onto the substrate, through predetermined processing such as decompression. Then, by the drawing apparatus 44, an image in which six LCD panels are arranged is formed on one substrate based on the design data 90. In this manner, the image of the LCD panel to be formed is drawn on the substrate, and ultimately, the LCD panel is obtained.

In this embodiment, the intermediate data (part data 110 of the accessories 94, panel arrangement information 112, part data 116a of the wiring portion 100, part data 116b and mark arrangement information 118a of the mark 102, and part data 116c and cell arrangement information 118b of the cell 104) is saved in the data storage section 64 and it is possible to change any portion of the intermediate data by the data edit apparatus 50.

Therefore, in this embodiment, it becomes possible to, when, for instance, a design is changed in the LCD panel or a part of the image to be drawn is changed due to a problem of the raster data conversion or the drawing apparatus 44 or the like, change the image for the LCD panel formation by changing a corresponding portion of the intermediate data without changing the design data 90. As a result, even when a part of the LCD panel image to be formed is changed due to a design change, a problem, or the like, conversion of the design data into raster data is not required, which makes it possible to shorten a time required before the changed image is drawn on the substrate again.

Next, a method of changing an image to be drawn in the drawing system 40 of this embodiment will be described.

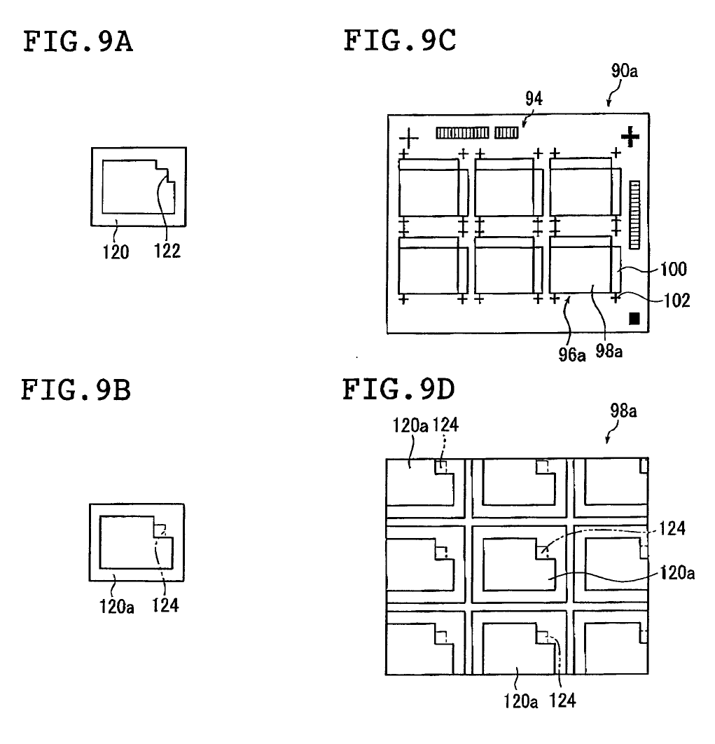

In this case, FIG. 9A is a schematic diagram showing a cell of a panel portion, FIG. 9B is a schematic diagram showing the cell of the panel portion after a change, FIG. 9C is a schematic diagram showing a synthesis image obtained in the edit/layout/synthesis section of the data edit apparatus of the drawing system of this embodiment, and FIG. 9D is a schematic diagram enlargedly showing a main portion of the panel portion of the synthesis image after the change.

How an image to be drawn is changed in the drawing system 40 of this embodiment will be described by taking a case, as an example, where the cell 120 shown in FIG. 9A of the LCD panel portion is changed to the cell 120a shown in FIG. 9B.

The LCD panel portion 96a shown in FIG. 9C having the cell 120 shown in FIG. 9A differs from the LCD panel portion 96 shown in FIG. 8A in the cell 120 composing the display panel portion 98a, and other structures are the same as those of the LCD panel portion 96 shown in FIG. 8A, so a detailed description thereof will be omitted.

Also in this case, six images of the LCD panel portion having the cell 120 shown in FIG. 9A is formed in one substrate area 92.

As described above, in the drawing data creation apparatus 46, the part data 110 of the accessories 94, the panel arrangement information 112, the part data 116a of the wiring portion 100, the part data 116b and the mark arrangement information 118a of the mark 102, and part data and cell arrangement information of the cell 120 are created from the design data and are saved in the data storage section 64 as intermediate data.

In the data edit apparatus 50, the intermediate data is read into the edit/layout/synthesis section 70 by the edit section 72 using the operation section 74, the edit/layout/synthesis section 70 performs layout/synthesis in the same manner as the layout synthesis section 62 to thereby create a synthesis image 90a shown in FIG. 9C, and the synthesis image 90a is displayed on the display section. This synthesis image 90a is in a bitmap form.

The cell 120 shown in FIG. 9A has a concave portion 122 in one corner portion. A change is made to fill this concave portion 122 to thereby obtain the cell 120a shown in FIG. 9B, which does not include the concave portion 122. In this case, the cell 120 is displayed as enlargedly displaying the display panel portion 98a of the synthesis image 90a.

Then, using the operation section 74, by the edit section 72, one cell 120 of the display panel portion 98a is changed to the cell 120a shown in FIG. 9B by making a change in which the concave portion 122 is filled by adding a member 124 to the concave portion 122. In this case, among the intermediate data saved in the data storage section 64, the part data of the cell 120 is also changed to the shape of the cell 120a.

In addition, merely by changing one cell 120 of the display panel portion 98a, every displayed cell 120 in the display panel portion 98a is changed to the cell 120a, resulting in that all cells 120a displayed in the display section are changed as shown in FIG. 9D. As a result, it becomes possible to confirm each changed portion by the display section of the data edit apparatus 50.

After the change to the cell 120a, each part data and the arrangement information for the each part data are again outputted from the data storage section 64 to the layout synthesis section 62, the layout/synthesis is performed, thereby forming the LCD panel image based on the design data on the substrate by the drawing apparatus 44. As a result, it becomes possible to confirm the image formed on the substrate.

As described above, in this embodiment, when there is a design change, it becomes possible to obtain drawing data (raster data) necessary for drawing by the drawing apparatus 44 merely by changing part data of each corresponding element in design data without changing the design data. As a result, conversion of the design data into raster data is unnecessary and when a design is changed, it becomes possible to shorten a time before an image formed on a substrate is confirmed.

It should be noted that in this embodiment, a change of an image to be formed is not limited to a change due to a design change, and also when a drawn image is different from design data due to a problem of the drawing data creation apparatus 46 or the drawing apparatus 44, it is possible to modify an image to be formed on a substrate in the same manner as in the case of the design change. Also in this case, conversion of the design data into raster data is unnecessary, which makes it possible to shorten a time before the image formed on the substrate is confirmed.

As described above, in this embodiment, conversion of design data as it is into raster data is unnecessary and a time before an image formed on a substrate is confirmed is shortened, so a time necessary for trial production at the time of product development can be shortened, which makes it possible to shorten a period of time of the product development. As a result, it becomes possible to introduce a new product early in the market.

In addition, in this embodiment, even when conversion accuracy at the time of conversion of design data into raster data is enhanced, the conversion of the design data as it is into the raster data is not required, so an influence of a design change or the like on trial production is reduced, which makes it possible to enhance image drawing accuracy and improve quality of a product obtained.

It should be noted that in the second aspect of the present invention, the design data may use a data format of GDSII, GDI II, ODB+, RS247X, or the like and have a hierarchical structure.

That is, similarly in the first aspect of the present invention, in the second aspect, an image of a layer of the LCD panel shown in FIG. 2A may be exposed on a substrate in the drawing apparatus, and as the design data therefor, the design data of the configuration shown in FIG. 2B can be used.

As described above, the extraction section 56 separates the design data into a repeated structural element that is repeatedly described in the design data and non-repeated structural element other than the repeated structural element. In this case, a structural element that is repeatedly described in one hierarchical layer of the design data is extracted. In other words, a repeated structural element that is repeatedly described in a hierarchical layer upper than the hierarchical layer, in which the structural element is described, is extracted. Accordingly, in the example shown in FIG. 2B, Structure_C, Structure_D, and Structure_E are extracted.

When the design data has a hierarchical structure in this manner, a repeated structural element that is repeatedly described is searched merely in a hierarchical layer basis, so it becomes possible to find the repeated structural element with ease.

Also, for instance, in the example shown in FIG. 2A, when an extraction condition is set to extract each repeated structural element in up to the third hierarchical layer, Structure_C and Structure_D each become the repeated structural element, which makes it possible to extract the repeated structural element with more ease.

It is preferable that the design data have a hierarchical structure in the manner described above because it becomes possible to obtain part data and layout information having a hierarchical structure such as the hierarchical structure shown in FIG. 7 with more ease.

The extraction method, the extraction apparatus, and the program, and the drawing data creation method and the drawing data creation apparatus of the present invention have been described above in detail with reference to various embodiments but the present invention is not limited to the embodiments described above and it is of course possible to make various changes and modifications without departing from the gist of the present invention.

What is claimed is:

1. An extraction method, comprising:
an acquiring step of acquiring design data that has a hierarchical structure and is converted into raster data corresponding to drawing onto a substrate; and
an extracting step of extracting from said design data a structural element that composes said design data, is repeatedly described in one hierarchical layer, and satisfies at least one of four extraction conditions concerning a size of said structural element, a number of times of repetition of said structural element in an upper structural element upper than said structural element, a number of lower structural elements composing said structural element, and a depth of said one hierarchical layer in which said structural element exists.

2. An extraction apparatus comprising:
an acquisition section for acquiring design data that has a hierarchical structure and is converted into raster data corresponding to drawing onto a substrate; and
an extraction section for analyzing said design data acquired by said acquisition section to extract a structural element that composes said design data, is repeatedly described in one hierarchical layer, and satisfies at least one of four extraction conditions concerning a size of said structural element, a number of times of repetition of said structural element in an upper structural element upper than said structural element, a number of lower structural elements composing the structural element, and a depth of said one hierarchical layer in which said structural element exists.

3. The extraction apparatus according to claim 2, wherein the extraction section includes:
first selection means for selecting said at least one of four extraction conditions; and
means for determining a threshold value for judging whether satisfying said at least one of said four extraction conditions or not.

4. The extraction apparatus according to claim 2, wherein:
said design data is created by giving a name to said structural element according to a predetermined naming rule; and
said extraction section includes:
a first extraction function for extracting said structural element using said four extraction conditions;
a second extraction function for extracting a structural element given a predetermined name using said predetermined naming rule in creation of said design data; and
second selection means for selecting one of said first extraction function and said second extraction function.

5. The extraction apparatus according to claim 2, wherein:
said extraction apparatus is used in a system capable of carrying out first data processing for converting structural elements extracted by said extraction section into the raster data according to kinds thereof, compressing said raster data, and rearranging said raster data based on position information of said structural elements detected by analyzing said design data, and second data processing for converting said design data into the raster data without performing extraction of said structural elements and compressing said raster data; and
said extraction apparatus further comprises estimation means for estimating a time required for said first data processing and a time required for said second data processing and performs extraction of said structural elements when a result of estimation by said estimation means shows that said time required for said first data processing is shorter than said time required for said second data processing.

6. An extraction apparatus comprising:
an acquisition section for acquiring design data that has a hierarchical structure, is converted into raster data corresponding to drawing onto a substrate, and is created by giving a name to a structural element in accordance with a predetermined naming rule; and
an extraction section for analyzing said design data acquired by said acquisition section to extract a structural element with a predetermined name, using said predetermined naming rules of structural elements composing said design data.

7. A program for causing a computer to execute processing for extracting, from design data that has a hierarchical structure and is converted into raster data corresponding to drawing onto a substrate, a structural element that composes said design data, is repeatedly described in one hierarchical layer, and satisfies at least one of four extraction conditions concerning a size of said structural element, a number of times of repetition of said structural element in an upper structural element upper than said structural element, a number of lower structural elements composing said structural element, and a depth of said one hierarchical layer in which said structural element exists.

8. A drawing data creation method of creating drawing data corresponding to drawing onto a substrate by rasterizing design data in which an image to be drawn on said substrate is described in a vector form, said drawing data creation method comprising:
a first step of extracting one or more first repeated structural elements, each being repeatedly described from structural elements composing said design data, separating said one or more first repeated structural elements from one or more first non-repeated structural elements, each being not repeatedly described, extracting layout information indicating a position of said extracted one or more first repeated structural elements on said substrate, and creating part data of said one or more first non-repeated structural elements through rasterizing;
a second step of repeatedly performing, predetermined times, said step of further extracting, from one first repeated structural element of said extracted one or more first repeated structural elements, one or more repeated structural elements, each being repeatedly described, separating one or more repeated structural elements from one or more non-repeated structural elements, each being not repeatedly described, extracting layout information indicating a position of said further extracted one or more repeated structural elements on said substrate, and creating part data of said one or more non-repeated structural elements through rasterizing:
a third step of creating part data of the remaining one or more repeated structural elements through rasterizing; and
a fourth step of saving said part data and said layout information of respective structural elements and creating said drawing data based on said part data and said layout information of said respective structural elements.

9. The drawing data creation method according to claim 8, wherein said second step is repeatedly performed until the further extraction of said one or more repeated structural elements becomes impossible.

10. The drawing data creation method according to claim 8, further comprising, when said image to be drawn on said substrate is changed, a step of changing at least one of said part data and said layout information.

11. The drawing data creation method according to claim 8, further comprising, when said image to be drawn on said substrate is changed, displaying said raster data of said drawing data, changing said displayed raster data of said drawing data in units of pixels, changing said part data including the changed pixels, and changing the displaying of the displayed raster data in accordance with the change.

12. A drawing data creation apparatus for creating drawing data corresponding to drawing onto a substrate by rasterizing design data in which an image to be drawn on said substrate is described in a vector form, comprising:
an extraction section for extracting one or more repeated structural elements, each being repeatedly described from among structural elements composing said design data, separating said one or more repeated structural elements from one or more non-repeated structural elements, each being not repeatedly described, extracting layout information showing a position of said extracted one or more repeated structural elements on said substrate, and performing, predetermined times, step of further extracting, from said extracted one or more repeated structural elements, one or more repeated structural elements, each being repeatedly described, separating said one or more repeated structural elements from one or more non-repeated structural elements, each being not repeatedly described, and extracting layout information indicating a position of the further extracted one or more repeated structural elements on said substrate;
a rasterizing section for creating part data of said one or more non-repeated structural elements through rasterizing and, when any one or more repeated structural elements remain in said design data even after further extraction of said one or more repeated structural elements are performed predetermined times, creating part data of the remaining one or more repeated structural elements through rasterizing;
a save section for saving said part data and said layout information of respective structural elements; and
a layout synthesis section for creating the raster data of said drawing data corresponding to the drawing onto said substrate based on said part data and said layout information of said respective structural elements.

13. The drawing data creation apparatus according to claim 12, further comprising
an edit section having a function for, when said image to be drawn on said substrate is changed, changing at least one of said part data and said layout information.

14. The drawing data creation apparatus according to claim 12, further comprising:
an edit layout synthesis section for creating said drawing data based on said part data and said layout information of said respective structural elements;
a display section for displaying said raster data obtained by said edit layout synthesis section; and
a change section having a function for changing said raster data obtained by said edit layout synthesis section in units of pixels, changing said part data including the changed pixels, and further changing the displaying by said display section based on said raster data.
